(19) United States
(12) Patent Application Publication
(10) Pub. No.: US 2025/0005100 A1
(43) Pub. Date: Jan. 2, 2025

(54) TECHNIQUES FOR CONTENTION-FREE ROUTING FOR NUMBER-THEORETIC- TRANSFORM AND INVERSE-NUMBER-THEORETIC-TRANSFORM COMPUTATIONS ROUTED THROUGH A PARALLEL PROCESSING DEVICE

(71) Applicant: Intel Corporation, Santa Clara, CA (US)

(72) Inventors: Raghavan KUMAR, Hillsboro, OR (US); AppaRao CHALLAGUNDLA, Austin, TX (US); Sanu K. MATHEW, Portland, OR (US); Christopher B. WILKERSON, Portland, OR (US); Adish VARTAK, Palo Alto, CA (US); Sachin TANEJA, Hillsboro, OR (US); Minxuan ZHOU, San Diego, CA (US); Lalith Dharmesh KETHARESWARAN, Austin, TX (US)

(21) Appl. No.: 18/217,564

(22) Filed: Jul. 1, 2023

(51) Int. Cl. G06F 17/14

(52) U.S. Cl. CPC G06F 17/14

(57) ABSTRACT

Examples include techniques for contention-free routing for number-theoretic-transform (NTT) or inverse-NTT (iNTT) computations routed through a parallel processing device. Examples include a tile array that includes a plurality of tiles arranged in a 2-dimensional mesh interconnect-based architecture. Each tile includes a plurality of compute elements configured to execute NTT or iNTT computations associated with a fully homomorphic encryption workload.

### STATEMENT REGARDING FEDERALLY SPONSORED RESEARCH

This invention was made with Government support under contract number HR0011-21-3-0003-0104 awarded by the Department of Defense. The Government has certain rights in this invention.

### TECHNICAL FIELD

Examples described herein are generally related to techniques associated with contention-free routing for number-theoretic transform (NTT) and inverse-NTT (iNTT) computations through a parallel processing device for accelerating fully homomorphic encryption (FHE) workloads.

### BACKGROUND

Number-theoretic-transforms (NTT) and inverse-NTT (iNTT) can be important operations for accelerating fully homomorphic encryption (FHE) workloads. NTT/iNTT computations/operations can be used to reduce runtime complexity of polynomial multiplications associated with FHE workloads from O(n²) to O(n log n), where n is the degree of the underlying polynomials. NTT and iNTT operations can be mapped for execution by computational elements included in a parallel processing device. The parallel processing device could be referred to as a type of accelerator device to accelerate execution of FHE workloads.

### BRIEF DESCRIPTION OF THE DRAWINGS

FIG. 1 illustrates an example system.

FIG. 2 illustrates an example connection scheme.

FIG. 3 illustrates an example route table.

FIG. 4 illustrates an example tile sub-system.

FIG. 5 illustrates an example tile.

FIG. 6 illustrates an example direction table.

FIG. 7 illustrates an example router sub-system for a tile.

FIG. 8 illustrates an example routing path.

FIG. 9 illustrates an example logic flow.

FIG. 10 illustrates an example computing system.

FIG. 11 illustrates a block diagram of an example processor and/or System on a Chip (SoC) that may have one or more cores and an integrated memory controller.

### DETAILED DESCRIPTION

In some examples, NTT and iNTT operations can be mapped for execution by computational elements included in a parallel processing device. The parallel processing device may include reconfigurable compute elements such reconfigurable butterfly circuits. These reconfigurable butterfly circuits can be arranged in separate groups organized in a plurality of tiles. These butterfly circuits can perform single instruction, multiple data (SIMD) add, multiply, multiply-and-accumulate, subtraction, etc. Unlike other SIMD operations, NTT operations also require shuffling of polynomial coefficients after computation on groups of butterfly circuits included in a respective tile. For example, for large polynomial ring sizes, this involves a significant amount of data movement between tiles. For example, a parallel processing device can include around 8,192 configurable butterfly circuits organized across 64 tiles. This equates to 128 butterfly circuits per tile and if each butterfly circuit has a 64 bit output, around 8,192 bits or 1 kilobyte (KB) of data can be moved across or between a pair of tiles. So for a 64 tile array, the resulting data movement would be about 64 KB. Moving this relatively large amount of data across all tiles of the parallel processing device needs a routing fabric to facilitate efficient data movement to achieve high throughput for NTT or iNTT operations. Efficient data movement can improve an overall performance of FHE workloads executed by the parallel processing device or accelerator implementing NTT/iNTT operations.

In some solutions, data movement across tiles of a parallel processing device that includes processing elements such as butterfly circuits involve dedicated point-to-point connections between tiles. For example, a dedicated point-to-point interconnect that involves Manhattan routing paths between tiles for a 64-tile array with 8,192 butterfly circuits organized in an 8×8 grid would need links capable of moving 1 KB of data between tiles, as mentioned above for NTT or iNTT operations. These 1 KB wide point-to-point connections move data from a source tile to a destination tile in the 64 tile array. This type of dedicated point-to-point connection scheme for NTT or iNTT operations can require a significant amount of routing channels and resources to ensure contention free routing for data movement between a source tile and a destination tile. Silicon area during a physical design flow could grow as much as 2-3 times to accommodate this type of dedicated point-to-point connection scheme to implement NTT/iNTT operations/computations.

A solution that attempts to mitigate silicon area growth for tile to tile data movement is to serialize or break up data movement via point-to-point connections into small chunks. The smaller chunks can reduce the width of data paths but a penalty will occur as NTT/iNTT operations/computations throughput will be reduced. Reduced throughput for NTT/iNTT operations/computations reduces overall performance for execution of FHE workloads.

Examples described in this disclosure present a scalable and reconfigurable parallel processing device having compute elements arranged to execute NTT and iNNT operations/computations that route data between tiles based on programmable contention-free routing schedules for NTT/iNTT operations/computations that is initiated at a beginning of an FHE workload execution. The programmable contention-free routing schedules cause generation or creation of routing tables for use to route data between tiles in a manner that boost throughput compared to serialized point-to-point connections and enables a user to program contention-free routing schedules that can provide latency versus throughput trade-off options to minimize silicon area growth. Latency versus throughput trade-off options would not be possible in dedicated point-to-point connections once silicon is taped out for a parallel processing device having dedicated point-to-point connections to move data between tiles for NTT/iNTT operations/computations.

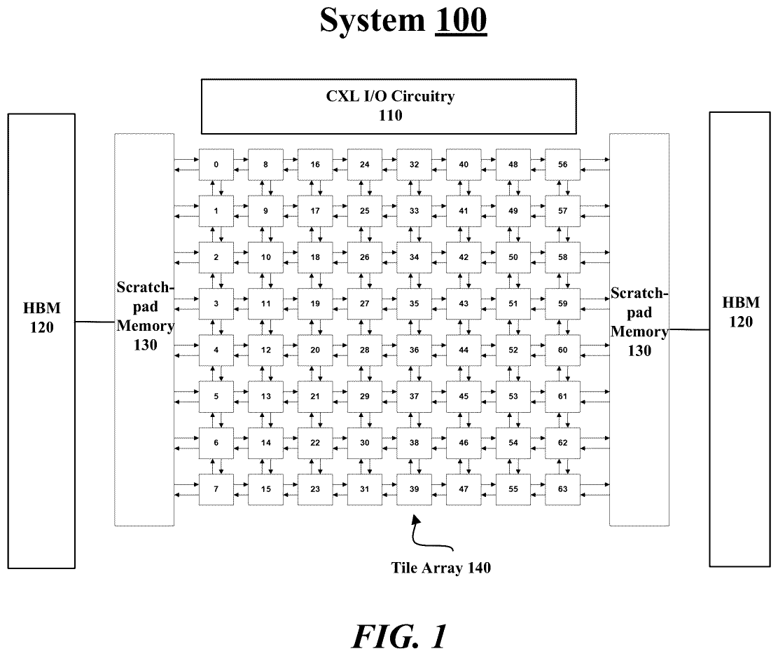

FIG. 1 illustrates an example system 100. In some examples, system 100 can be included in and/or operate within a compute platform. The compute platform, for example, could be located in a data center included in, for example, cloud computing infrastructure, examples are not limited to system 100 included in a compute platform located in a data center. As shown in FIG. 1, system 100 includes compute express link (CXL) input/output (I/O) circuitry 110, high bandwidth memory (HBM) 120, scratchpad memory 130 or tile array 140.

In some examples, system 100 can be configured as a parallel processing device or accelerator to perform NTT/iNTT operations/computations for accelerating FHE workloads. For these examples, CXL I/O circuitry 110 can be configured to couple with one or more host central processing units (CPUs—not shown) to receive instructions and/or data via circuitry designed to operate in compliance with one or more CXL specifications published by the CXL Consortium to included, but not limited to, CXL Specification, Rev. 2.0, Ver. 1.0, published Oct. 26, 2020, or CXL Specification, Rev. 3.0, Ver. 1.0, published Aug. 1, 2022. Also, CXL I/O circuitry 110 can be configured to enable one or more host CPUs to obtain data associated with execution of accelerated FHE workloads by compute elements included in interconnected tiles of tile array 140. For example, data (e.g., ciphertext or processed ciphertext) may be received to or pulled from HBM 120 and CXL I/O circuitry 110 can facilitate the data movement into or out of HBM 120 as part of execution of accelerated FHE workloads. Also, scratchpad memory 130 can be a type of memory (e.g., register files) that can be proportionately allocated to tiles included in tile array 140 to facilitate execution of the accelerated FHE workloads and to perform NTT/iNTT operations.

In some examples, as described in more detail below, tile array 140 can be arranged in an 8×8 tile configuration as shown in FIG. 1 that includes tiles 0 to 63. For these examples, each tile can include, but is not limited to, 128 compute elements (not shown in FIG. 1). Also, as described in more detail later, the 128 compute elements can be 128 separately reconfigurable butterfly circuits, that are configured to compute output terms associated with polynomial coefficients for NTT/iNTT operations/computations. As shown in FIG. 1, tiles 0 to 63 can be interconnected via point-to-point connections via a 2-dimensional (2D) mesh interconnect-based architecture. The 2D mesh enables communications between adjacent tiles using single-hop links. Tiles included in tile array 140 can be augmented with router circuitry that can route data received via inputs or sent via outputs across all 4 directions.

Examples are not limited to use of CXL I/O circuitry such as CXL I/O circuitry 110 to facilitate receiving instructions and/or data or providing executed results associated with FHE workloads. Other types of I/O circuitry and/or additional circuitry to receive instructions and/or data or provide executed results are contemplated.

Examples are not limited to HBM such as HBM 120 for receiving data to be processed or to store information associated with instructions to execute an FHE workload or execution results of the FHE workload. Other types of volatile memory or non-volatile memory are contemplated for use in system 100. Other type of volatile memory can include, but are not limited to, Dynamic RAM (DRAM), DDR synchronous dynamic RAM (DDR SDRAM), GDDR, static random-access memory (SRAM), thyristor RAM (T-RAM) or zero-capacitor RAM (Z-RAM). Non-volatile types of memory can include byte or block addressable types of non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

According to some examples, system 100 can be included in a system-on-a-chip (SoC). An SoC is a term often used to describe a device or system having a compute elements and associated circuitry (e.g., I/O circuitry, butterfly circuits, power delivery circuitry, memory controller circuitry, memory circuitry, etc.) integrated monolithically into a single integrated circuit (“IC”) die, or chip. For example, a device, computing platform or computing system could have one or more compute elements (e.g., butterfly circuits) and associated circuitry (e.g., I/O circuitry, power delivery circuitry, memory controller circuitry, memory circuitry, etc.) arranged in a disaggregated collection of discrete dies, tiles and/or chiplets (e.g., one or more discrete compute die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

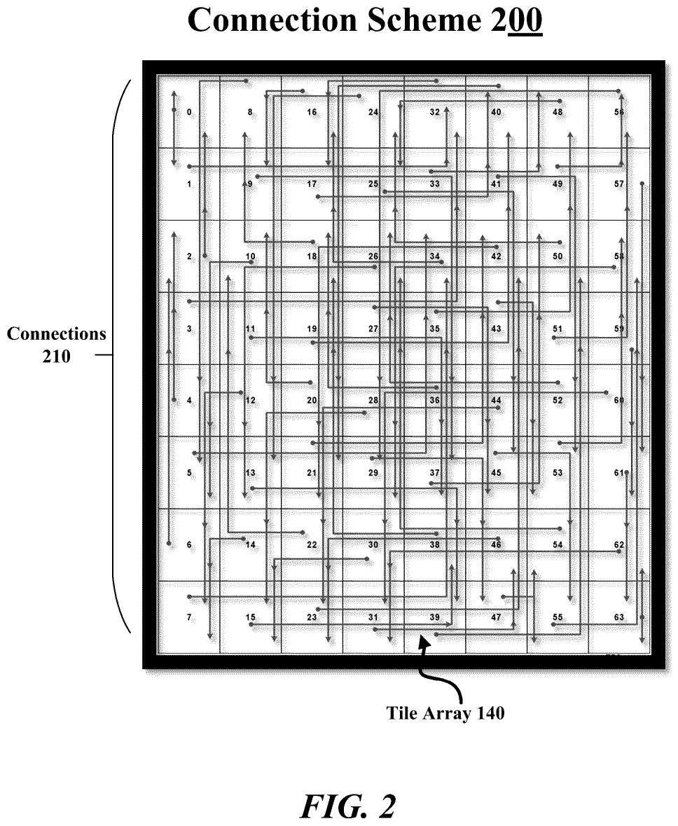

FIG. 2 illustrates an example connection scheme 200. According to some examples, connection scheme 200 shows how an 8×8 grid of tiles 0-63 of tile array 140 can be interconnected via connections 210, to perform an NTT operation on polynomials with 16,394 coefficients. For these examples, each tile can include 128 compute elements or butterfly circuits. Each point-to-point link included in connections 210 between tiles can be configured to carry 64 bits output from each of 128 butterfly circuits included in a single tile. So, each point-to-point link included in connections 210 can be configured to carry around 8, 192 bits or 1 KB of data.

Connection scheme 200 is an example of how paths can be routed between tiles to implement an NTT operation using a Manhattan source-destination routing scheme. For implementing an iNTT operation, paths between tiles included in tile array 140 will have source and destination tile ordering reversed. In other words, the direction of the arrows shown in FIG. 2 are reversed. For example, for implementing an NTT operation, data from a source tile of 1 is routed to a destination tile of 32 through tiles 9, 17, 25 and 33. For implementing an iNTT operation, tile 32 is the source and tile 1 is the destination and the routing of data is through 33, 25, 17 and 9 to reach destination tile 1.

According to some examples, a scalable and reconfigurable method to implement connections between tiles executing NTT or iNTT operations/computations associated with an FHE workload can occur over a 2D mesh interconnect such as shown in FIG. 1 for system 100. The scalable and reconfigurable method can enable a contention free routing by construction. As described in more detail below, tiles 0-63 of tile array 140 can each include router circuitry that is arranged to direct incoming packets to appropriate output ports using routing tables. As data routing paths for NTT/iNTT operations/computations are known or predetermined, a user can program contention free routing schedules to routing tables at a beginning of an FHE workload. Butterfly circuitry included in each tile of tile array 140 can be arranged to execute in a SIMD nature for the FHE workload. The SIMD nature for the FHE workload enables a reuse of router circuitry between NTT and iNTT operations/computations by replicating only the routing table, while sharing decoder circuitry.

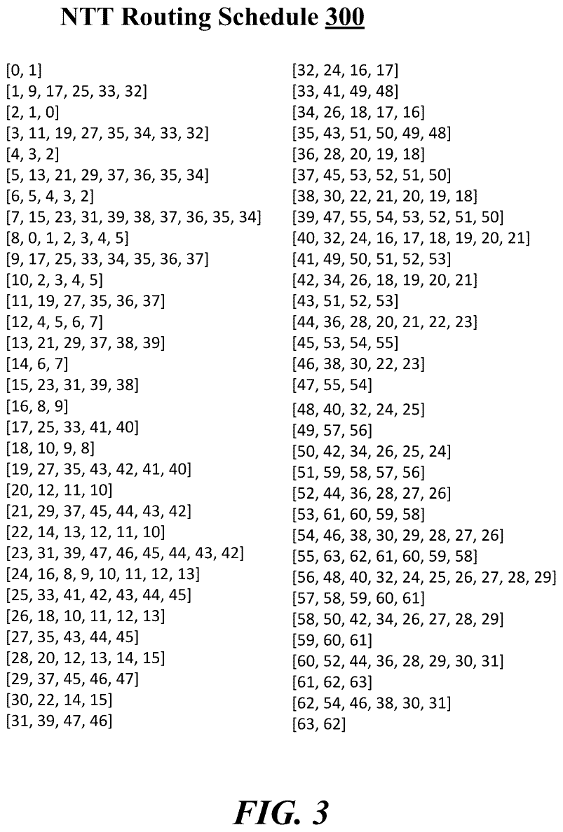

FIG. 3 illustrates an example NTT routing schedule 300. As mentioned previously, data movement for NTT and iNTT operations/computations can be achieved over a 2D mesh interconnect-based architecture as shown in FIG. 1 using a Manhattan source-destination routing scheme as shown in FIG. 2. NTT routing schedule 300 can be encoded into routing tables that provide contention-free routing paths for router circuitry to use for routing packets through a tile array. Contention can be defined as a scenario, where two incoming packets received at router circuitry at a tile have a same output port for routing. Routing paths encoded in routing tables based on NTT routing schedule 300 can be constructed such that they are contention-free by construction. Contention-free routes for all 64 tiles included in tile array 140 are shown in FIG. 3 for a 16K polynomial ring size example NTT operation/computations.

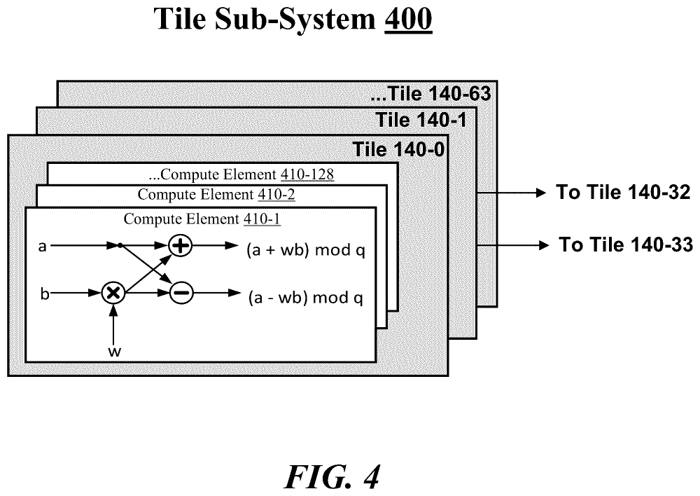

FIG. 4 illustrates an example tile sub-system 400. According to some examples, as shown in FIG. 4, tile sub-system 400 includes tiles 140-0 to 140-63 of tile array 140. Also, compute elements 410-1 to 410-128 illustrate the 128 compute elements included in tile 140-0. For these examples, compute elements 410-1 to 410-128 can include decimation-in-time (DIT) butterfly circuits that includes a modular multiplier coupled to an adder and subtractor. Although not shown in FIG. 4, other types of butterfly circuits such as decimation-in-frequency (DIF) butterfly circuits are contemplated, so examples are not limited to DIT butterfly circuits. NTT operations/computations for FHE workloads can be performed by the 128 compute elements configured as butterfly circuits and included in each tile of tile array 140. The NTT operations can include each butterfly circuit computing output terms a+b*w, a−b*w, where a and b are polynomial coefficients, while w is a twiddle factor, that depends on an underlying modulus term.

Unlike add, subtraction and multiplication operations, NTT operations/computations also involve a fixed permutation of butterfly circuit outputs, where a permutation pattern depends on the degree of an underlying polynomial. Connection scheme 200 shown in FIG. 2 depicts a permutation network for a 16K polynomial ring size mapped to tile array 140 in an 8×8 grid. According to some examples, the two outputs lanes from butterfly circuits included in the 128 compute elements of a tile are sent to two destination tiles, where each destination tile is to receive one of the output lanes. For example, as shown in FIG. 4, output lanes from tile 140-1 are sent to tiles 140-32 and 140-33.

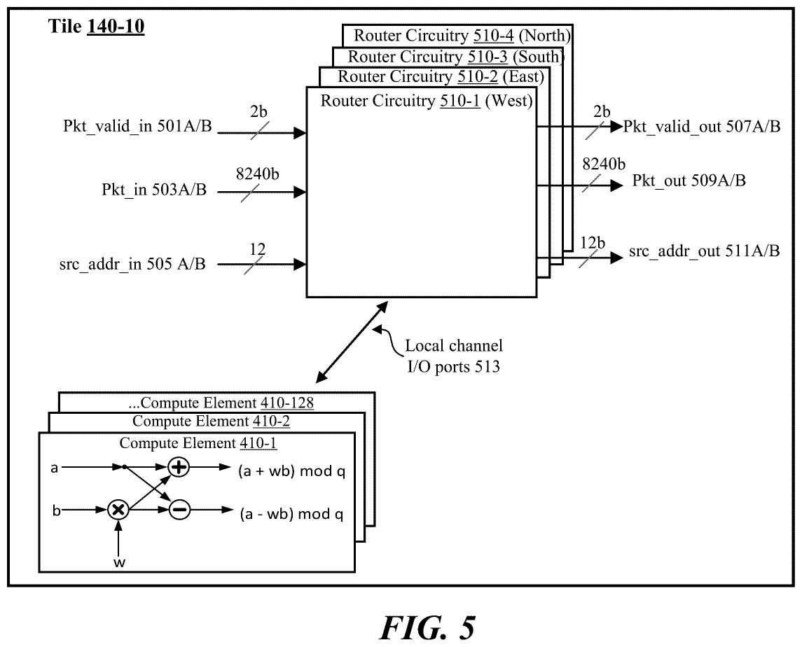

FIG. 5 illustrates an example tile 140-10 from tile array 140. In some examples, as shown in FIG. 5, tile 140-10 includes router circuitry 510-1 to 510-4. For these examples, router circuitry 510 is replicated 4 times to service up to 4 directions (west, east, south, north) simultaneously/concurrently and to also service routing of data to local compute elements 410-1 to 410-128 if data is destined for tile 140-10. Example routing activities that occur within/by components of router circuitry 510 are described in more detail below.

According to some examples, in order to accommodate two output lanes from compute elements 410-1 to 410-128, router circuitry 510 can implement two identical routing channels A and B. Routing channels A/B are not shown in FIG. 5 but are implied via Pkt_valid_in 501A/B, Pkt_in 503A/B, src-addr_in 505A/B, Pkt_valid-out 507A/B, Pkt_out 509A/B and src_addr_out 511A/B signals. For example, Pkt_valid_in 501A/B signal is shown in FIG. 5 as including a 2 bit signal−1 bit for the A channel and 1 bit for the B channel. Similarly, the number of bits shown for the other signals are equally split between the A and B channels.

In some examples, Pkt_valid_in 501A/B signals can carry 2 bits of data to indicate a valid packet has been sent to tile 140-10, Pkt_in 503A/B signals can carry 8240 bits of data included in packets to be processed by compute elements 410, src_addr_in 505A/B signals can carry 12 bits of data to indicate a source address for the data to be processed for an NTT/iNTT operation/computation. Also, Pkt_valid_out 507A/B signals can carry 2 bits of data to indicate that tile 140-10 is sending a valid packet to a next tile, Pkt_out 509A/B signals can carry 8240 bits of data included in packets to be sent to a destination tile, and src_addr_out 511A/B signals can carry 12 bits to indicate the source address for the data to be processed for the NTT/iNTT operation/computation. Examples are not limited to the bits shown in FIG. 5 for A/B signals that are based on a 16K polynomial mapped to tile array 140. The size of the polynomial ring mapped to a tile array will increase or decrease bits carried by at least Pkt_in 503A/B, src_addr_in 505A/B, Pkt_out 509A/B, or src_addr_out 511A/B signals to implement NTT/iNTT operations.

Although only tile 140-10 is shown in FIG. 5, all tiles included in tile array 140 can have the same replicated router circuitry.

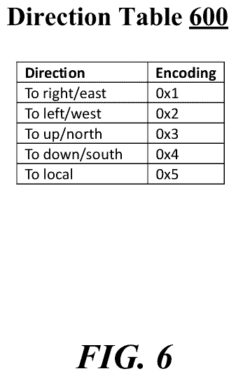

FIG. 6 illustrates an example direction table 600. According to some examples, as shown in FIG. 6, direction table 600 provides example encodings to indicate which output port to use as a routing path to send received data packets in 4 possible directions (0x1-0x4), as well as local delivery (0x5) if the current tile is the destination for the received data packets. In an example of an 8×8 tile array, a routing table having 64 source address entries contains values that encode the 4 possible directions, as well as local delivery as shown in direction table 600. A source address of a received packet (e.g., received via src_add_in 505), is used as a look-up table address to fetch an encoded value for that source address from the routing table. The encoded value to be based on a contention-free route through the 8×8 tile array from the source tile to a destination tile for an NTT/iNTT operation/computation.

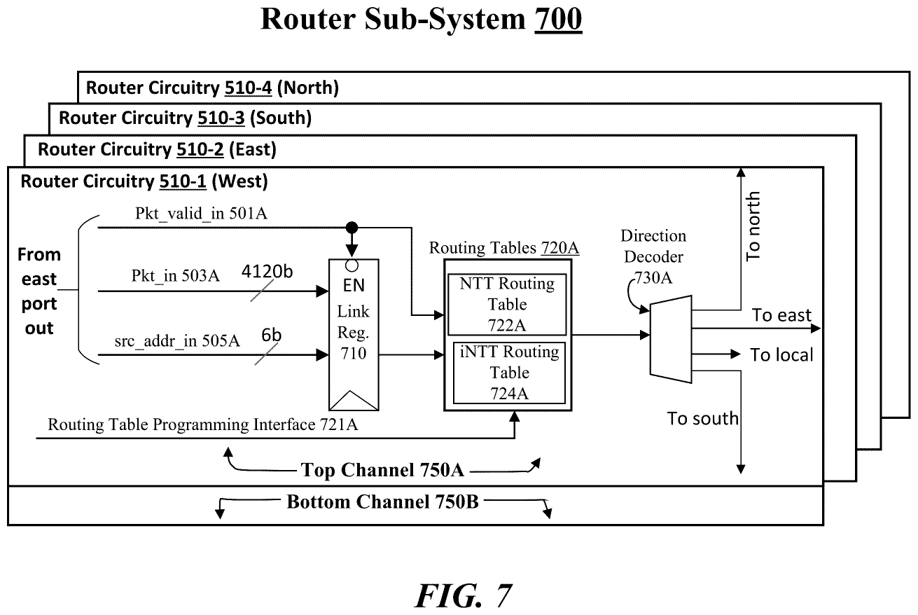

FIG. 7 illustrates an example router sub-system 700. In some examples, router sub-system 700 shows components of router circuitry 510-1 (e.g., router circuitry 510-1 for tile 140-10) For these examples, as shown in FIG. 7 a top channel 750A of router circuitry 510-1 includes a link register 710A, a routing table programming interface 721A, routing tables 720A, and a direction decoder 730A. Routing tables 720A include an NTT routing table 722A that includes contention-free routes through tile array 140 for NTT operations/computations. Routing tables 720A can be reconfigured for router circuitry 510-1 via routing table programming interface 721A. Routing tables 720A also include an iNTT routing table 724A that includes contention-free routes through tile array 140 for iNTT operations/computations. Both routing tables included in routing tables 720A can be reconfigured for router circuitry 510-1 via routing table programming interface 721A. For example, programmable registers or allocated memory of a tile can be used to maintain routing tables 720A and these programmable registers or allocated memory can be programmed/accessed via routing table programming interface 721A to configure or reconfigure routing tables 720A (e.g., at initiation of an FHE workload).

Although not shown in FIG. 7 bottom channel 750B includes duplicated components of a link register 710B, a routing table programming interface 721B, routing tables 720B, and a direction decoder 730B. According to some examples, identical components included in top channel 750A and bottom channel 750B can be designed to accommodate two output lanes for compute elements 410-1 to 410-128 included in a tile.

As mentioned above and shown in both FIGS. 5 and 7, router circuitry 510-1 is replicated in router circuitry 510-2, 510-3 and 510-4 to service up to 4 directions simultaneously. In some examples, an incoming packet received via Pkt_in 503A associated with a corresponding valid signal received via Pkt_valid_in 501A and a source address of the packet indicated in src_addr_in 505A. For these examples, the source address of the packet is captured in link register 710A. The source address can then be used as a look-up table address to fetch an encoded value for that source address from a routing table included in routing tables 720A. Direction decoder 730A can cause the packet to be routed to an output port based on the encoded value that is encoded, for example, according to example direction table 600.

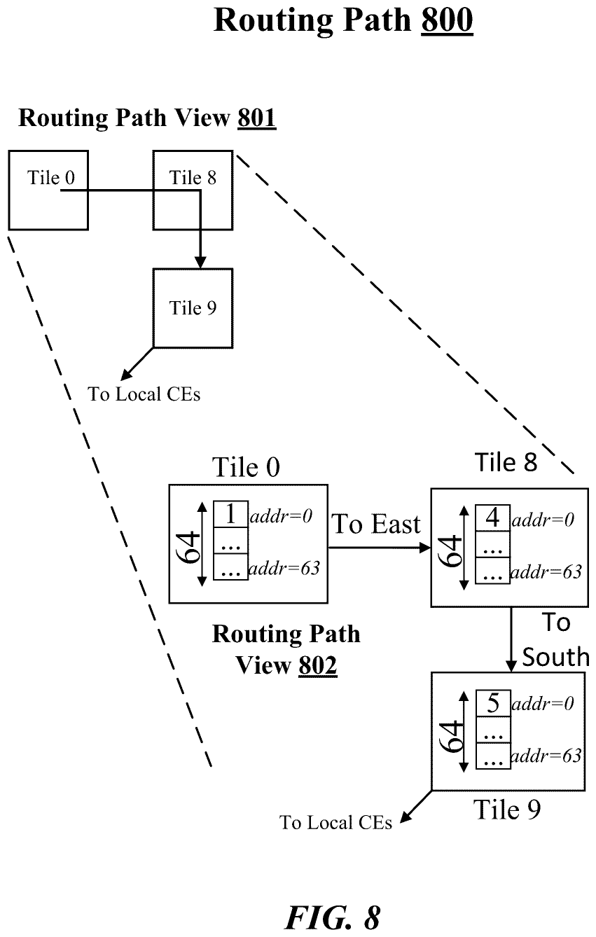

FIG. 8 illustrates an example routing path 800. In some examples, as shown in FIG. 8, routing path 800 includes a high level routing path view 801 and an expanded routing path view 802. For these examples, routing path view 801 depicts a contention-fee route for packets sourced from tile 0 and destined for local compute elements at tile 9. The contention-free route, for example, can be based on routing tables maintained in routing circuitry of tile 0, tile 8 and tile 9 such as routing tables 720A/B maintained in router circuitry 510-1 to 510-4 as described above.

According to some examples, expanded routing path view 802 shows how routing tables maintained at each tile's routing circuitry can use a source address for tile 0 that is shown in FIG. 8 as “addr=0” in a 64 entry routing table (1 entry per tile of 8×8 array) to determine an encoded value to use to route packets sourced from tile 0 to a packet destination of compute elements at tile 9. For these examples, tile 0 has an encoded value of “1” in its routing table for source address “0” to indicate routing a packet via an east output port as the first leg in the contention-free route that goes through tile 8 to reach compute elements of tile 9. Tile 8 has an encoded value of “4” in its routing table for source address “0” to indicate routing a packet sourced from tile 0 to a south output port as the second leg in the contention-free route to compute elements of tile 9. Tile 9 has an encoded value of “5” in its routing table for source address “0” to indicate routing a packet sourced from tile 0 to local compute elements as the final leg in the contention-free route to compute elements of tile 9.

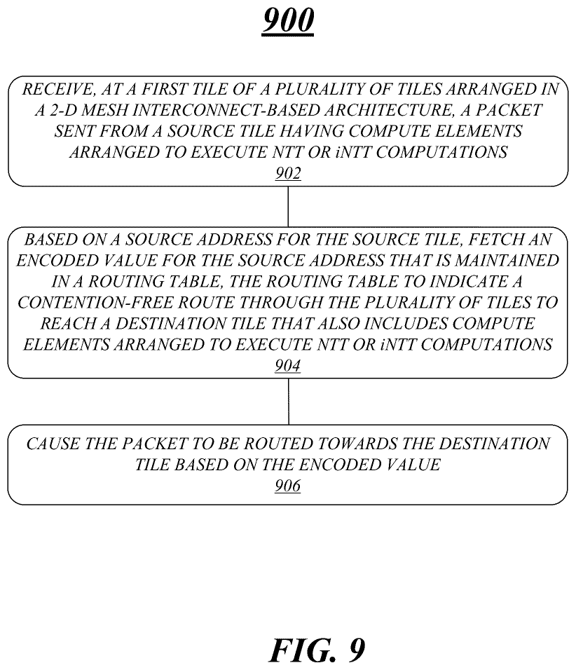

FIG. 9 illustrates an example logic flow 900. Logic flow 900 is representative of the operations implemented by logic and/or features of a router circuitry resident on or closely coupled with a tile. For example, logic and/or features of router circuitry 510-1, 510-2, 510-3 or 510-4 as shown in FIGS. 5 and 7 and described above for router sub-system 700. The router circuitry can be included in a tile such as tile 140-10 of tile array 140 that includes a plurality of compute elements such as compute elements 410-1 to 410-128 as shown in FIGS. 4 and 5.

In some examples, as shown in FIG. 9, logic flow 900 at block 902 can receive, at a first tile of a plurality of tiles arranged in a 2-D mesh interconnect-based architecture, a packet sent from a source tile having compute elements arranged to execute NTT or iNTT computations. For example, route circuitry 510-1 of tile 140-10 receives a packet sent from a source tile included in tile array 140 in association with NTT computations, the packet received via an Pkt_in 503A signal of top channel 750A.

According to some examples, logic flow 900 at block 904 can based a source address for the source tile, fetch an encoded value for the source address that is maintained in a routing table, the routing table to indicate a contention-free route through the plurality of tiles to reach a destination tile that also includes compute elements arranged to execute NTT or iNTT computations. For example, router circuitry 510-1 uses the source address for the source tile to fetch an encode value for the source address from NTT routing table 722A. The encode value to indicate which output port of top channel 750A to route the packet received from the source tile.

In some examples, logic flow 900 at block 906 can cause the packet to be routed towards the destination tile based on the encoded value. For example, direction decoder 730A uses the fetch encode value (e.g., encoded according to example direction table 600) to determine whether the packet is routed towards one of a west, east, north, south or local output port to reach its destination. In some examples, the tile including the router circuitry 510-1 is also the destination tile. For these examples, the packet is routed towards a local output port that sends the packet to compute elements 410-1 to 410-128.

The logic flow shown in FIG. 9 can be representative of example methodologies for performing novel aspects described in this disclosure. While, for purposes of simplicity of explanation, the one or more methodologies shown herein are shown and described as a series of acts, those skilled in the art will understand and appreciate that the methodologies are not limited by the order of acts. Some acts can, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology can be required for a novel implementation.

A logic flow can be implemented in software, firmware, and/or hardware. In software and firmware embodiments, a software or logic flow can be implemented by computer executable instructions stored on at least one non-transitory computer readable medium or machine readable medium, such as an optical, magnetic or semiconductor storage. The embodiments are not limited in this context.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

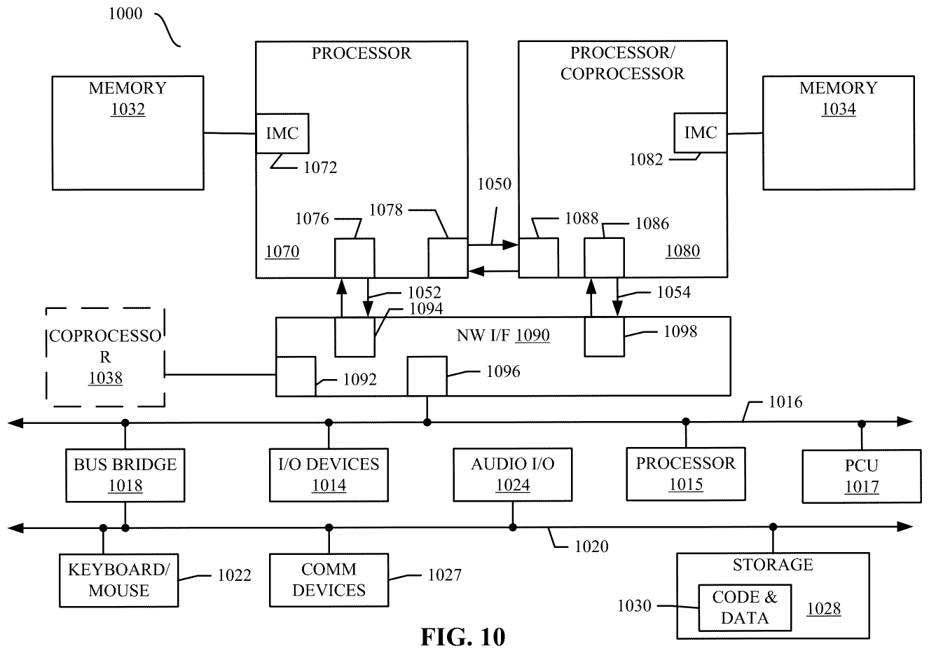

FIG. 10 illustrates an example computing system. Multiprocessor system 1000 is an interfaced system and includes a plurality of processors or cores including a first processor 1070 and a second processor 1080 coupled via an interface 1050 such as a point-to-point (P-P) interconnect, a fabric, and/or bus. In some examples, the first processor 1070 and the second processor 1080 are homogeneous. In some examples, first processor 1070 and the second processor 1080 are heterogenous. Though the example system 1000 is shown to have two processors, the system may have three or more processors, or may be a single processor system. In some examples, the computing system is a system on a chip (SoC).

Processors 1070 and 1080 are shown including integrated memory controller (IMC) circuitry 1072 and 1082, respectively. Processor 1070 also includes interface circuits 1076 and 1078; similarly, second processor 1080 includes interface circuits 1086 and 1088. Processors 1070, 1080 may exchange information via the interface 1050 using interface circuits 1078, 1088. IMCs 1072 and 1082 couple the processors 1070, 1080 to respective memories, namely a memory 1032 and a memory 1034, which may be portions of main memory locally attached to the respective processors.

Processors 1070, 1080 may each exchange information with a network interface (NW I/F) 1090 via individual interfaces 1052, 1054 using interface circuits 1076, 1094, 1086, 1098. The network interface 1090 (e.g., one or more of an interconnect, bus, and/or fabric, and in some examples is a chipset) may optionally exchange information with a coprocessor 1038 via an interface circuit 1092. In some examples, the coprocessor 1038 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1070, 1080 or outside of both processors, yet connected with the processors via an interface such as P-P interconnect, such that either or both processors' local cache information may be stored in the shared cache if a processor is placed into a low power mode.

Network interface 1090 may be coupled to a first interface 1016 via interface circuit 1096. In some examples, first interface 1016 may be an interface such as a Peripheral Component Interconnect (PCI) interconnect, a PCI Express interconnect or another I/O interconnect. In some examples, first interface 1016 is coupled to a power control unit (PCU) 1017, which may include circuitry, software, and/or firmware to perform power management operations with regard to the processors 1070, 1080 and/or co-processor 1038. PCU 1017 provides control information to a voltage regulator (not shown) to cause the voltage regulator to generate the appropriate regulated voltage. PCU 1017 also provides control information to control the operating voltage generated. In various examples, PCU 1017 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1017 is illustrated as being present as logic separate from the processor 1070 and/or processor 1080. In other cases, PCU 1017 may execute on a given one or more of cores (not shown) of processor 1070 or 1080. In some cases, PCU 1017 may be implemented as a microcontroller (dedicated or general-purpose) or other control logic configured to execute its own dedicated power management code, sometimes referred to as P-code. In yet other examples, power management operations to be performed by PCU 1017 may be implemented externally to a processor, such as by way of a separate power management integrated circuit (PMIC) or another component external to the processor. In yet other examples, power management operations to be performed by PCU 1017 may be implemented within BIOS or other system software.

Various I/O devices 1014 may be coupled to first interface 1016, along with a bus bridge 1018 which couples first interface 1016 to a second interface 1020. In some examples, one or more additional processor(s) 1015, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1016. In some examples, second interface 1020 may be a low pin count (LPC) interface. Various devices may be coupled to second interface 1020 including, for example, a keyboard and/or mouse 1022, communication devices 1027 and storage circuitry 1028. Storage circuitry 1028 may be one or more non-transitory machine-readable storage media as described below, such as a disk drive or other mass storage device which may include instructions/code and data 1030 and may implement the storage 'ISAB03 in some examples. Further, an audio I/O 1024 may be coupled to second interface 1020. Note that other architectures than the point-to-point architecture described above are possible. For example, instead of the point-to-point architecture, a system such as multiprocessor system 1000 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

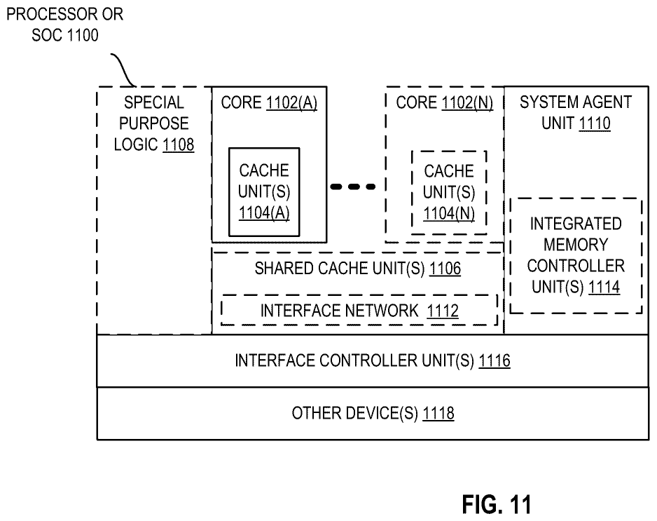

FIG. 11 illustrates a block diagram of an example processor and/or SoC 1100 that may have one or more cores and an integrated memory controller. The solid lined boxes illustrate a processor 1100 with a single core 1102(A), system agent unit circuitry 1110, and a set of one or more interface controller unit(s) circuitry 1116, while the optional addition of the dashed lined boxes illustrates an alternative processor 1100 with multiple cores 1102(A)-(N), a set of one or more integrated memory controller unit(s) circuitry 1114 in the system agent unit circuitry 1110, and special purpose logic 1108, as well as a set of one or more interface controller units circuitry 1116. Note that the processor 1100 may be one of the processors 1070 or 1080, or co-processor 1038 or 1015 of FIG. 10.

Thus, different implementations of the processor 1100 may include: 1) a CPU with the special purpose logic 1108 being integrated graphics and/or scientific (throughput) logic (which may include one or more cores, not shown), and the cores 1102(A)-(N) being one or more general purpose cores (e.g., general purpose in-order cores, general purpose out-of-order cores, or a combination of the two); 2) a coprocessor with the cores 1102(A)-(N) being a large number of special purpose cores intended primarily for graphics and/or scientific (throughput); and 3) a coprocessor with the cores 1102(A)-(N) being a large number of general purpose in-order cores. Thus, the processor 1100 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1100 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1104(A)-(N) within the cores 1102(A)-(N), a set of one or more shared cache unit(s) circuitry 1106, and external memory (not shown) coupled to the set of integrated memory controller unit(s) circuitry 1114. The set of one or more shared cache unit(s) circuitry 1106 may include one or more mid-level caches, such as level 2 (L2), level 3 (L3), level 4 (L4), or other levels of cache, such as a last level cache (LLC), and/or combinations thereof. While in some examples interface network circuitry 1112 (e.g., a ring interconnect) interfaces the special purpose logic 1108 (e.g., integrated graphics logic), the set of shared cache unit(s) circuitry 1106, and the system agent unit circuitry 1110, alternative examples use any number of well-known techniques for interfacing such units. In some examples, coherency is maintained between one or more of the shared cache unit(s) circuitry 1106 and cores 1102(A)-(N). In some examples, interface controller units circuitry 1116 couple the cores 1102 to one or more other devices 1118 such as one or more I/O devices, storage, one or more communication devices (e.g., wireless networking, wired networking, etc.), etc.

In some examples, one or more of the cores 1102(A)-(N) are capable of multi-threading. The system agent unit circuitry 1110 includes those components coordinating and operating cores 1102(A)-(N). The system agent unit circuitry 1110 may include, for example, power control unit (PCU) circuitry and/or display unit circuitry (not shown). The PCU may be or may include logic and components needed for regulating the power state of the cores 1102(A)-(N) and/or the special purpose logic 1108 (e.g., integrated graphics logic). The display unit circuitry is for driving one or more externally connected displays.

The cores 1102(A)-(N) may be homogenous in terms of instruction set architecture (ISA). Alternatively, the cores 1102(A)-(N) may be heterogeneous in terms of ISA; that is, a subset of the cores 1102(A)-(N) may be capable of executing an ISA, while other cores may be capable of executing only a subset of that ISA or another ISA.

The following examples pertain to additional examples of technologies disclosed herein.

Example 1. An example apparatus can include at least one compute element arranged to execute NTT or iNTT computations, the at least one compute element maintained at a first tile of a plurality of tiles arranged in a 2-dimensional mesh interconnect-based architecture. The apparatus can also include router circuitry maintained at the first tile. The router circuitry can receive a packet sent from a source tile from among the plurality of tiles, the source tile includes compute elements arranged to execute NTT or iNTT computations. The router circuitry can also, based on a source address for the source tile, fetch an encoded value for the source address that is maintained in a routing table. The routing table can indicate a contention-free route through the plurality of tiles to reach a destination tile that also includes compute elements arranged to execute NTT or iNTT computations. The router circuitry can also cause the packet to be routed towards the destination tile based on the encoded value.

Example 2. The apparatus of example 1, the routing table can be capable of being reconfigured responsive to a change to the NTT or iNTT computations to be executed by computing elements at tiles included in the plurality of tiles such that contention free routes through the plurality of tiles correspondingly change.

Example 3. The apparatus of example 1, the compute elements of the source tile can include butterfly circuits to generate 2 outputs based on 2 inputs to execute NTT or iNTT computations. The received packet can include data generated by butterfly circuits at the source tile that is from 1 of the 2 outputs.

Example 4. The apparatus of example 1, the NTT or iNTT computations can be associated with a 16,384 polynomial ring size to be used for execution of a fully homomorphic encryption workload. The plurality of tiles can include 64 tiles, each tile including 128 compute elements.

Example 5. The apparatus of example 1, the first tile can be the destination tile, and the packet can be routed to the compute elements of the first tile.

Example 6. The apparatus of example 1, the router circuitry can include an east, a west, a north, a south or a local output port, wherein the encoded value indicates which output port to route the packet to cause the packet to be routed towards the destination tile.

Example 7. The apparatus of example 6, the router circuitry can be capable of concurrently routing separate packets via at least two of the east, the west, the north, the south or the local output ports.

Example 8. An example method can include receiving, at a first tile of a plurality of tiles arranged in a 2-dimensional mesh interconnect-based architecture, a packet sent from a source tile having compute elements arranged to execute NTT or iNTT computations. The method can also include, based on a source address for the source tile, fetching an encoded value for the source address that is maintained in a routing table, wherein the routing table indicates a contention-free route through the plurality of tiles to reach a destination tile that also includes compute elements arranged to execute NTT or iNTT computations. The method can also include causing the packet to be routed towards the destination tile based on the encoded value.

Example 9. The method of example 8, the routing table can be capable of being reconfigured responsive to a change to the NTT or iNTT computations to be executed by computing elements at tiles included in the plurality of tiles such that contention free routes through the plurality of tiles correspondingly change.

Example 10. The method of example 8, the compute elements of the source tile can include butterfly circuits to generate 2 outputs based on 2 inputs to execute NTT or iNTT computations. The received packet can include data generated by butterfly circuits at the source tile that is from 1 of the 2 outputs.

Example 11. The method of example 8, the NTT or iNTT computations can be associated with a 16,384 polynomial ring size to be used for execution of a fully homomorphic encryption workload. The plurality of tiles can include 64 tiles, each tile including 128 compute elements.

Example 12. The method of example 8, the first tile can be the destination tile, and the packet can be routed to the compute elements of the first tile.

Example 13. The method of example 8, the packet can be received by router circuitry of the first tile.

Example 14. The method of example 13, the encoded value can indicate one of an east, a west, a north, a south or a local output port of the router circuitry to be used to route the packet towards the destination tile.

Example 15. The method of example 14, the router circuitry can be arranged to concurrently route separate packets via at least two of the east, the west, the north, the south or the local output ports.

Example 16. An example at least one machine readable medium can include a plurality of instructions that in response to being executed by a system can cause the system to carry out a method according to any one of examples 8 to 15.

Example 17. An example apparatus can include means for performing the methods of any one of examples 8 to 15.

Example 18. An example system can include a source tile from among a plurality of tiles arranged in a 2-dimensional mesh interconnect-based architecture, the source tile can include compute elements arranged to execute NTT) or iNTT computations. The system can also include a destination tile from among the plurality of tiles. The destination tile can also include compute elements arranged to execute NTT or iNTT computations. The system can also include an intermediate tile from among the plurality of tiles. The intermediate tile can also include compute elements arranged to execute NTT or iNTT computations. The intermediate tile can include router circuitry to receive a packet sent from the source tile. The router circuitry can also, based on a source address for the source tile, fetch an encoded value for the source address that is maintained in a routing table. The routing table can indicate a contention-free route through the plurality of tiles to reach the destination tile. The routing circuitry can also cause the packet to be routed towards the destination tile based on the encoded value.

Example 19. The system of example 18, the routing table can be capable of being reconfigured responsive to a change to the NTT or iNTT computations to be executed by computing elements at tiles included in the plurality of tiles such that contention free routes through the plurality of tiles correspondingly change.

Example 20. The system of example 18, the compute elements of the source tile can include butterfly circuits to generate 2 outputs based on 2 inputs to execute NTT or iNTT computations. The received packet can include data generated by butterfly circuits at the source tile that is from 1 of the 2 outputs.

Example 21. The system of example 18, the NTT or iNTT computations can be associated with a 16,384 polynomial ring size to be used for execution of a fully homomorphic encryption workload. The plurality of tiles can include 64 tiles, each tile including 128 compute elements.

Example 22. The system of example 18, the router circuitry can include an east, a west, a north, a south or a local output port. The encoded value can indicate which output port to route the packet to cause the packet to be routed towards the destination tile.

Example 23. The system of example 22, the router circuitry can be capable of concurrently routing separate packets via at least two of the east, the west, the north, the south or the local output ports.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

While various examples described herein could use the System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single integrated circuit (“IC”) die, or chip, the present disclosure is not limited in that respect. For example, in various examples of the present disclosure, a device or system could have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
at least one compute element arranged to execute number-theoretic-transform (NTT) or inverse-NTT (iNTT) computations, the at least one compute element maintained at a first tile of a plurality of tiles arranged in a 2-dimensional mesh interconnect-based architecture; and
router circuitry maintained at the first tile, the router circuitry to:
receive a packet sent from a source tile from among the plurality of tiles, the source tile includes compute elements arranged to execute NTT or iNTT computations;
based on a source address for the source tile, fetch an encoded value for the source address that is maintained in a routing table, wherein the routing table indicates a contention-free route through the plurality of tiles to reach a destination tile that also includes compute elements arranged to execute NTT or iNTT computations; and
cause the packet to be routed towards the destination tile based on the encoded value.

2. The apparatus of claim 1, wherein the routing table is capable of being reconfigured responsive to a change to the NTT or iNTT computations to be executed by computing elements at tiles included in the plurality of tiles such that contention free routes through the plurality of tiles correspondingly change.

3. The apparatus of claim 1, wherein the compute elements of the source tile comprise butterfly circuits to generate 2 outputs based on 2 inputs to execute NTT or iNTT computations, wherein the received packet includes data generated by butterfly circuits at the source tile that is from 1 of the 2 outputs.

4. The apparatus of claim 1, wherein the NTT or iNTT computations are associated with a 16,384 polynomial ring size to be used for execution of a fully homomorphic encryption workload, wherein the plurality of tiles includes 64 tiles, each tile including 128 compute elements.

5. The apparatus of claim 1, wherein the first tile is the destination tile, and the packet is to be routed to the compute elements of the first tile.

6. The apparatus of claim 1, wherein the router circuitry includes an east, a west, a north, a south or a local output port, wherein the encoded value indicates which output port to route the packet to cause the packet to be routed towards the destination tile.

7. The apparatus of claim 6, wherein the router circuitry is capable of concurrently routing separate packets via at least two of the east, the west, the north, the south or the local output ports.

8. A method comprising:
receiving, at a first tile of a plurality of tiles arranged in a 2-dimensional mesh interconnect-based architecture, a packet sent from a source tile having compute elements arranged to execute number-theoretic-transform (NTT) or inverse-NTT (iNTT) computations;
based on a source address for the source tile, fetching an encoded value for the source address that is maintained in a routing table, wherein the routing table indicates a contention-free route through the plurality of tiles to reach a destination tile that also includes compute elements arranged to execute NTT or iNTT computations; and
causing the packet to be routed towards the destination tile based on the encoded value.

9. The method of claim 8, wherein the routing table is capable of being reconfigured responsive to a change to the NTT or iNTT computations to be executed by computing elements at tiles included in the plurality of tiles such that contention free routes through the plurality of tiles correspondingly change.

10. The method of claim 8, wherein the compute elements of the source tile comprise butterfly circuits to generate 2 outputs based on 2 inputs to execute NTT or iNTT computations, wherein the received packet includes data generated by butterfly circuits at the source tile that is from 1 of the 2 outputs.

11. The method of claim 8, wherein the NTT or iNTT computations are associated with a 16,384 polynomial ring size to be used for execution of a fully homomorphic encryption workload, wherein the plurality of tiles includes 64 tiles, each tile including 128 compute elements.

12. The method of claim 8, wherein the first tile is the destination tile, and the packet is to be routed to the compute elements of the first tile.

13. The method of claim 8, wherein the packet is received by router circuitry of the first tile.

14. The method of claim 13, wherein the encoded value indicates one of an east, a west, a north, a south or a local output port of the router circuitry to be used to route the packet towards the destination tile.

15. The method of claim 14, wherein the router circuitry is arranged to concurrently route separate packets via at least two of the east, the west, the north, the south or the local output ports.

16. An system comprising:
a source tile from among a plurality of tiles arranged in a 2-dimensional mesh interconnect-based architecture, the source tile includes compute elements arranged to execute number-theoretic-transform (NTT) or inverse-NTT (iNTT) computations;
a destination tile from among the plurality of tiles, the destination tile to also include compute elements arranged to execute NTT or iNTT computations; and
an intermediate tile from among the plurality of tiles, the intermediate tile to also include compute elements arranged to execute NTT or iNTT computations, wherein the intermediate tile includes router circuitry to:
receive a packet sent from the source tile;
based on a source address for the source tile, fetch an encoded value for the source address that is maintained in a routing table, wherein the routing table indicates a contention-free route through the plurality of tiles to reach the destination tile; and
cause the packet to be routed towards the destination tile based on the encoded value.

17. The system of claim 16, wherein the routing table is capable of being reconfigured responsive to a change to the NTT or iNTT computations to be executed by computing elements at tiles included in the plurality of tiles such that contention free routes through the plurality of tiles correspondingly change.

18. The system of claim 16, wherein the compute elements of the source tile comprise butterfly circuits to generate 2 outputs based on 2 inputs to execute NTT or iNTT computations, wherein the received packet includes data generated by butterfly circuits at the source tile that is from 1 of the 2 outputs.

19. The system of claim 16, wherein the NTT or iNTT computations are associated with a 16,384 polynomial ring size to be used for execution of a fully homomorphic encryption workload, wherein the plurality of tiles include 64 tiles, each tile including 128 compute elements.

20. The system of claim 16, wherein the router circuitry includes an east, a west, a north, a south or a local output port, wherein the encoded value indicates which output port to route the packet to cause the packet to be routed towards the destination tile.
